(19) United States
(12) Patent Application Publication
(10) Pub. No.: US 2022/0091882 A1
(43) Pub. Date: Mar. 24, 2022

(54) SYSTEM, CONTROL DEVICE, AND PROCESSING DEVICE

(71) Applicant: KABUSHIKI KAISHA TOKAI RIKA DENKI SEISAKUSHO, Aichi (JP)

(72) Inventor: Yosuke OHASHI, Aichi (JP)

(73) Assignee: KABUSHIKI KAISHA TOKAI RIKA DENKI SEISAKUSHO, Aichi (JP)

(21) Appl. No.: 17/352,677

(22) Filed: Jun. 21, 2021

(30) Foreign Application Priority Data
Sep. 23, 2020 (JP) 2020-158310

(51) Int. Cl. G06F 9/48; H04W 12/06; H04W 4/029; H04W 4/02

(52) U.S. Cl. CPC G06F 9/4881; H04W 4/023; H04W 4/029; H04W 12/06

(57) ABSTRACT

An object of the present invention is to improve security and assure responsiveness.

Provided is a system including: a first processing device; at least one or more second processing devices; and a control device. The first processing device and the at least one or more second processing devices execute respective designated processes more than once. The control device controls execution of a subsequent process, which follows the designated process, on the basis of a result determined as a result that satisfies a designated condition for first time, among results of the respective designated processes executed more than once by the first processing device and the at least one or more second processing devices.

### CROSS REFERENCE TO RELATED APPLICATION(S)

This application is based upon and claims benefit of priority from Japanese Patent Application No. 2020-158310, filed on Sep. 23, 2020, the entire contents of which are incorporated herein by reference.

### BACKGROUND

The present invention relates to a system, a control device, and a processing device

In recent years, technologies of performing authentication in accordance with a result of transmitting/receiving signals between devices have been developed. For example, JP H11-208419A discloses a system of authenticating a portable device on the basis of signals transmitted and received between an in-vehicle device and a portable device and controlling a control target device.

In the case of further improving security of the above-described system, it is also considered that a condition for controlling the control target device is complicated, for example. However, if the condition is complicated, there is a possibility of reducing responsiveness.

Accordingly, the present invention is made in view of the aforementioned issue, and an object of the present invention is to improve security and assure responsiveness.

### SUMMARY

To solve the above-described problems, according to an aspect of the present invention, there is provided a system including: a first processing device; at least one or more second processing devices; and a control device. The first processing device and the at least one or more second processing devices execute respective designated processes more than once. The control device controls execution of a subsequent process, which follows the designated process, on the basis of a result determined as a result that satisfies a designated condition for first time, among results of the respective designated processes executed more than once by the first processing device and the at least one or more second processing devices.

In addition, to solve the above-described problems, according to another aspect of the present invention, there is provided a control device including a control section configured to control execution of a subsequent process, which follows a designated process, on the basis of results of the respective designated processes executed more than once by a plurality of processing devices. The control section controls execution of the subsequent process on the basis of a result determined as a result that satisfies a designated condition for first time, among the results of the respective designated processes executed more than once by the plurality of processing devices.

In addition, to solve the above-described problems, according to another aspect of the present invention, there is provided a processing device including a processing section configured to execute a designated process more than once. The processing section transmits a result determined as a result that satisfies a designated condition for first time to a control device that executes a subsequent process following the designated process on the basis of the result, among results of the designated process executed more than once by the processing section and results of the designated process executed more than once by at least one or more other processing devices.

As described above, according to the present invention, it is possible to improve security and assure responsiveness.

### BRIEF DESCRIPTION OF THE DRAWINGS

FIG. 1 is a block diagram illustrating a configuration example of a system 1 according to an embodiment of the present invention.

FIG. 2 is a block diagram illustrating a functional configuration example of a first processing device 10 according to the embodiment.

FIG. 3 is a block diagram illustrating a functional configuration example of a second processing device 20 according to the embodiment.

FIG. 4 is a block diagram illustrating a functional configuration example of a control device 30 according to the embodiment.

FIG. 5 is a block diagram illustrating a functional configuration example of a portable device 50 according to the embodiment.

FIG. 6 is a sequence diagram illustrating an example of a flow of information communication in the system 1 according to the embodiment.

FIG. 7 is a sequence diagram illustrating an example of a flow of information communication in the system 1 according to the embodiment.

FIG. 8 is a diagram illustrating an example of control over subsequent processes based on ranging results according to the embodiment.

FIG. 9 is a diagram illustrating an example of control over subsequent processes based on ranging values according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

<<1.1. System Configuration Example>>

First, a configuration example of a system 1 according to an embodiment of the present invention will be described.

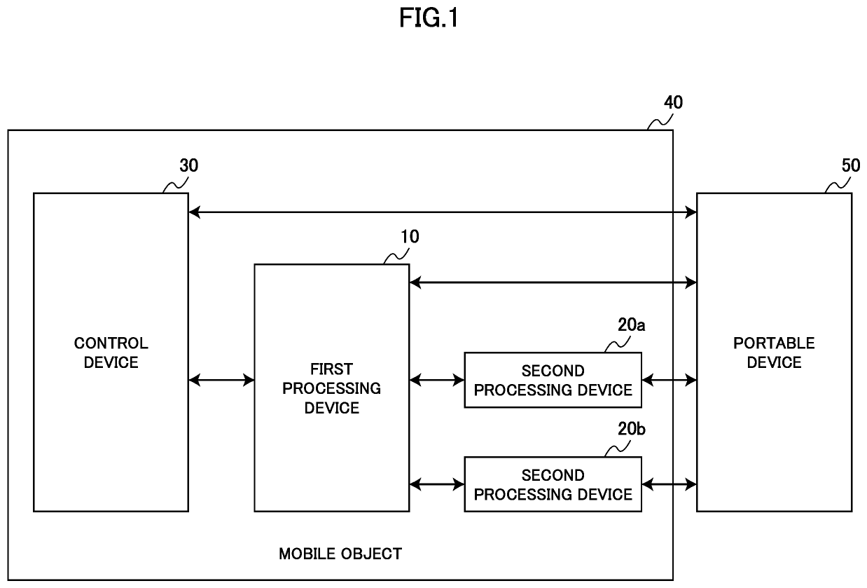

FIG. 1 is a block diagram illustrating the configuration example of the system 1 according to the present embodiment.

As illustrated in FIG. 1, the system 1 according to the present embodiment includes a first processing device 10, at least one or more second processing devices 20, and a control device 30, which are installed in a same mobile object 40. Examples of the mobile object 40 include a vehicle.

In addition, the system 1 according to the present embodiment includes a portable device 50 that performs wireless communication with the above-described devices installed in the mobile object 40.

(First Processing Device 10)

The first processing device 10 according to the present embodiment executes a designated process more than once.

For example, the designated process executed by the first processing device 10 according to the present embodiment may be the same as a process executed by the second processing devices 20, that is, these processes are in common with each other.

For example, the designated process according to the present embodiment may be a process based on a result of the wireless communication.

Examples of the process based on a result of the wireless communication include a process of estimating a positional relation between the portable device 50 and the first processing device 10 or one of the second processing devices 20 on the basis of wireless signals transmitted/received to/from the portable device 50.

For example, the positional relation may include a distance between the portable device 50 and the first processing device 10 or the second processing device 20.

In this case, the designated process according to the present embodiment may be ranging for estimating a distance between the portable device 50 and the first processing device 10 or each of the second processing devices 20.

In addition, for example, the positional relation may include an angle of the portable device 50 with respect to the first processing device 10 or one of the second processing devices 20.

In this case, the designated process according to the present embodiment may be a process of estimating an angle of arrival of a wireless signal transmitted from the portable device 50 with respect to the first processing device 10 or each of the second processing devices 20.

On the other hand, the designated process according to the present embodiment is not limited to the above-described examples. For example, the designated process according to the present embodiment may be a process of performing authentication based on respective images captured by the first processing device 10 and the second processing devices 20.

Examples of the process include face authentication based on a captured image of a face of a user, and gait authentication based on a captured image of a gait of a user.

The designated process according to the present embodiment is appropriately designed depending on a target or the like, to which the system 1 is applied.

In addition, the first processing device 10 according to the present embodiment may operate as a master that controls the at least one or more second processing devices that operate as slaves.

In this case, the first processing device 10 according to the present embodiment may receive a result of the designated process or a determination result from the at least one or more second processing devices 20, the determination result indicating whether or not the result of the designated process satisfies a designated condition.

(Second Processing Device 20)

The second processing device 20 according to the present embodiment executes a designated process more than once.

The system 1 according to the present embodiment includes the at least one or more second processing devices 20.

Note that, FIG. 1 illustrates the example in which the system 1 includes a second processing device 20a and a second processing device 20b. However, the number of the second processing devices 20 according to the present embodiment is not limited thereto.

The system 1 according to the present embodiment may include three or more second processing devices 20.

In addition, the second processing devices 20 according to the present embodiment may operate as the slaves that execute a process under the control of the first processing device 10, which operates as the master.

(Control Device 30)

The control device 30 according to the present embodiment controls execution of a subsequent process, which follows the designated process, on the basis of a result determined as a result that satisfies a designated condition for the first time, among results of the respective designated processes executed more than once by the first processing device 10 and the at least one or more second processing devices 20.

In addition, the control device 30 according to the present embodiment may perform authentication based on wireless signals transmitted/received to/from the portable device 50, and may control execution of the subsequent process further on the basis of a result of the authentication.

Note that, for example, the subsequent process according to the present embodiment includes various kinds of processes performed by a control target device, which is included in the mobile object 40 provided with the control device 30.

Examples of the control target device include a door, an engine, a light, and the like of the mobile object 40.

For example, the subsequent process according to the present embodiment may be a process of unlocking the door of the mobile object 40.

Alternatively, for example, the subsequent process according to the present embodiment may be a process of starting the engine of the mobile object 40.

Alternatively, for example, the subsequent process according to the present embodiment may be a process of turning on the light of the mobile object 40.

(Portable Device 50)

The portable device 50 according to the present embodiment is a terminal carried by a user of the mobile object 40 (such as an owner of the mobile object 40 or a borrower who is allowed to use the mobile object 40).

The portable device 50 according to the present embodiment performs wireless communication with each of the first processing device 10, the second processing devices 20, and the control device 30, which are installed in the mobile object 40.

The configuration example of the system 1 according to the present embodiment has been described above. Note that, the configuration described above with reference to FIG. 1 is a mere example. The configuration of the system 1 according to the present embodiment is not limited thereto.

For example, the second processing devices 20 according to the present embodiment do not always have to be connected to the first processing device 10. The second processing devices 20 according to the present embodiment may be directly connected to the control device 30.

The configuration of the system 1 according to the present embodiment may be flexibly modified in accordance with specifications and operations.

<<1.2. Functional Configuration Example of First Processing Device 10>>

Next, functional configuration examples of respective structural elements of the system 1 according to the present embodiment will be described.

First, a functional configuration example of the first processing device 10 according to the present embodiment will be described.

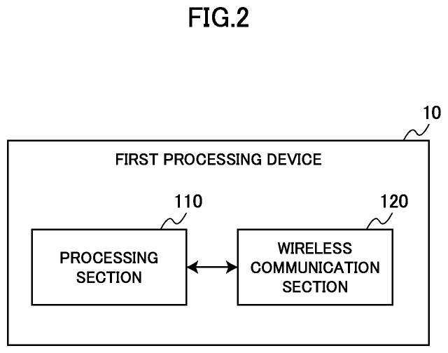

FIG. 2 is a block diagram illustrating the functional configuration example of the first processing device 10 according to the present embodiment.

As illustrated in FIG. 2, the first processing device 10 according to the present embodiment includes a processing section 110 and a wireless communication section 120.

(Processing Section 110)

The processing section 110 according to the present embodiment executes a designated process.

The designated process may be a process based on a result of wireless communication performed by the wireless communication section 120.

In addition, the processing section 110 according to the present embodiment transmits a result determined as a result that satisfies a designated condition for the first time to the control device 30, among results of the designated process executed more than once by the processing section 110 and results of the respective designated processes executed more than once by the at least one or more second processing devices 20.

For example, the processing section 110 according to the present embodiment may transmit the result through Local Interconnect Network (LIN) communication, Controller Area Network (CAN) communication, or the like.

Note that, the processing section 110 according to the present embodiment may determine whether or not each of the result of the designated process executed by the processing section 110 and the results of the designated processes executed by the at least one or more second processing devices 20 satisfies the designated condition.

In this case, the processing section 110 according to the present embodiment receives the results of the designated processes from the at least one or more second processing devices 20 through the LIN communication or the CAN communication.

On the other hand, the processing section 110 according to the present embodiment may receive a determination result from the second processing device 20 through the LIN communication or the CAN communication, the determination result indicating whether or not the result of the designated process executed by the second processing device 20 satisfies the designated condition.

Note that, the functions of the processing section 110 according to the present embodiment are implemented by a processor such as a CPU.

(Wireless Communication Section 120)

The wireless communication device 120 according to the present embodiment performs wireless communication with the portable device 50 in conformity with a first communication standard.

Therefore, the wireless communication section 120 according to the present embodiment includes an antenna for transmitting/receiving wireless signals in conformity with the first communication standard.

Note that, the first communication standard according to the present embodiment may be decided depending on the designated processes to be executed by the first processing device 10 and the second processing devices 20.

For example, in the case where the designated process according to the present embodiment is the process of estimating a positional relation between the portable device 50 and the first processing device 10 or the second processing device 20, ultra-wideband (UWB) wireless communication may be adopted as the first communication standard.

In this case, the wireless communication section 120 transmits/receives ultra-wideband signals (hereinafter, also referred to as UWB signals) to/from the portable device 50. In addition, the processing section 110 may perform ranging and estimate the angle of arrival on the basis of the transmitted/received UWB signals.

On the other hand, in the case where the designated process according to the present embodiment is not the process based on transmission/reception of the wireless signals such as the face authentication or the gait authentication, the first processing device 10 does not always have to include the wireless communication section 120.

The functional configuration example of the first processing device 10 according to the present embodiment has been described above. Note that, the functional configuration described above with reference to FIG. 2 is a mere example. The functional configuration of the first processing device 10 according to the present embodiment is not limited thereto. The functional configuration of the first processing device 10 according to the present embodiment can be flexibly modified in accordance with specifications and operations.

<<1.3. Functional Configuration Example of Second Processing Device 20>>

Next, a functional configuration example of the second processing device 20 according to the present embodiment will be described.

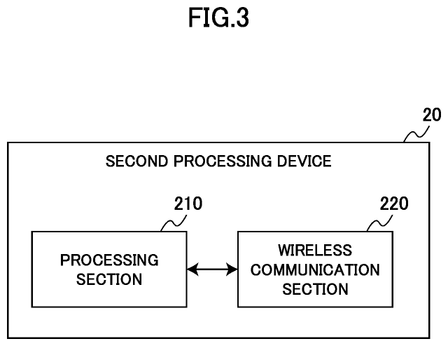

FIG. 3 is a block diagram illustrating the functional configuration example of the second processing device 20 according to the present embodiment.

As illustrated in FIG. 3, the second processing device 20 according to the present embodiment includes a processing section 210 and a wireless communication section 220.

(Processing Section 210)

The processing section 210 according to the present embodiment executes a designated process.

The designated process may be a process based on a result of wireless communication performed by the wireless communication section 220.

In addition, the processing section 210 according to the present embodiment may transmit a result of the designated process executed by the processing section 210 to the first processing device 10 through the LIN communication or the CAN communication.

On the other hand, the processing section 210 according to the present embodiment may determine whether or not the designated process executed by the processing section 210 satisfies a designated condition, and may transmit a result of the determination to the first processing device 10 through the LIN communication or the CAN communication.

The functions of the processing section 210 according to the present embodiment are implemented by a processor such as a CPU.

(Wireless Communication Section 220)

The wireless communication device 220 according to the present embodiment performs wireless communication with the portable device 50 in conformity with the first communication standard.

Therefore, the wireless communication section 220 according to the present embodiment includes an antenna for transmitting/receiving wireless signals in conformity with the first communication standard.

The functional configuration example of the second processing device 20 according to the present embodiment has been described above. Note that, the functional configuration described above with reference to FIG. 3 is a mere example. The functional configuration of the second processing device 20 according to the present embodiment is not limited thereto. The functional configuration of the second processing device 20 according to the present embodiment can be flexibly modified in accordance with specifications and operations.

<<1.4. Functional Configuration of Control Device 30>>

Next, a functional configuration example of the control device 30 according to the present embodiment will be described.

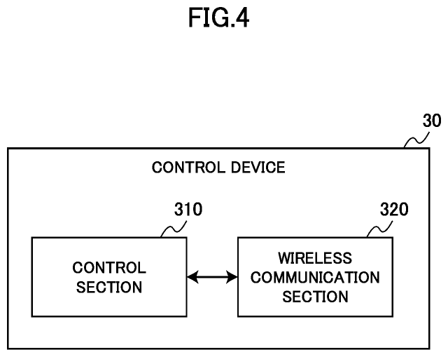

FIG. 4 is a block diagram illustrating the functional configuration example of the control device 30 according to the present embodiment.

As illustrated in FIG. 4, the control device 30 according to the present embodiment includes a control section 310 and a wireless communication section 320.

(Control Section 310)

The control section 310 according to the present embodiment controls execution of a subsequent process, which follows the designated processes, on the basis of results of the respective designated processes executed more than once by the first processing device 10 and the at least one or more second processing devices 20.

At this time, one of features of the control section 310 according to the present embodiment is to control execution of the subsequent process on the basis of a result determined as a result that satisfies a designated condition for the first time, among the results of the respective designated processes executed more than once by the first processing device 10 and the at least one or more second processing devices 20.

For example, the control section 310 according to the present embodiment may receive the result determined as a result that satisfies the designated condition for the first time from the first processing device 10, and may control execution of the subsequent process on the basis of the result.

On the other hand, the control section 310 according to the present embodiment may receive a result of the designated process from the first processing device 10 or one of the second processing devices 20 each time the result is generated, and the control section 310 may determine whether or not the result satisfies the designated condition each time the result is received.

In this case, the control section 310 according to the present embodiment may execute the subsequent process on the basis of a result determined as a result that satisfies the designated condition for the first time.

In addition, the control section 310 according to the present embodiment may perform authentication based on wireless signals transmitted/received between the wireless communication section 320 and the portable device 50, and may control execution of the subsequent process further on the basis of a result of the authentication.

The functions of the control section 310 according to the present embodiment are implemented by a processor such as a CPU.

(Wireless Communication Section 320)

The wireless communication section 320 according to the present embodiment performs wireless communication with the portable device 50 in conformity with a second communication standard, which is different from the first communication standard.

Therefore, the wireless communication section 320 according to the present embodiment includes an antenna for transmitting/receiving wireless signals in conformity with the second communication standard.

Examples of the second communication standard according to the present embodiment include wireless communication using low frequency (LF) band signals and ultra high frequency (UHF) band signals.

The functional configuration example of the control device 30 according to the present embodiment has been described above. Note that, the functional configuration described above with reference to FIG. 4 is a mere example. The functional configuration of the control device 30 according to the present embodiment is not limited thereto. The configuration of the control device 30 according to the present embodiment can be flexibly modified in accordance with specifications and operations.

<<1.5. Functional Configuration Example of Portable Device 10>>

Next, a functional configuration example of the portable device 50 according to the present embodiment will be described.

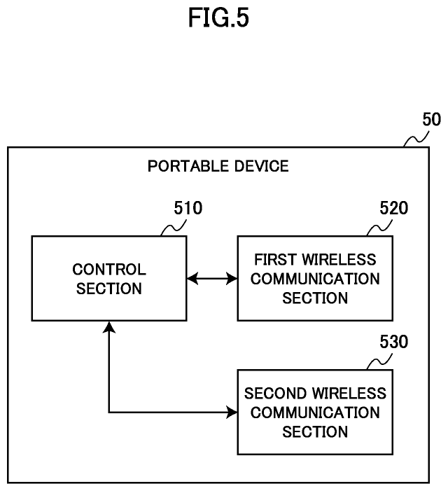

FIG. 5 is a block diagram illustrating the functional configuration example of the portable device 50 according to the present embodiment.

As illustrated in FIG. 5, the portable device 50 according to the present embodiment includes a control section 510, a first wireless communication section 520, and a second wireless communication section 530.

(Control Section 510)

The control section 510 according to the present embodiment controls structural elements included in the portable device 50.

The functions of the control section 510 according to the present embodiment are implemented by a processor such as a CPU.

(First Wireless Communication Section 520)

The first wireless communication device 520 according to the present embodiment performs wireless communication with the first processing device 10 and each of the second processing devices 20 in conformity with the first communication standard.

Therefore, the first wireless communication section 520 according to the present embodiment includes an antenna for transmitting/receiving wireless signals in conformity with the first communication standard.

(Second Wireless Communication Section 530)

The second wireless communication device 530 according to the present embodiment performs wireless communication with the control device 30 in conformity with the second communication standard.

Therefore, the second wireless communication section 530 according to the present embodiment includes an antenna for transmitting/receiving wireless signals in conformity with the second communication standard.

The functional configuration example of the portable device 50 according to the present embodiment has been described above. Note that, the functional configuration described above with reference to FIG. 5 is a mere example. The functional configuration of the portable device 50 according to the present embodiment is not limited thereto. The functional configuration of the portable device 50 according to the present embodiment can be flexibly modified in accordance with specifications and operations.

<<1.6. Details of Operation>>

Next, details of operation of the system 1 according to the present embodiment will be described.

As described above, in recent years, technologies of authenticating a portable device on the basis of wireless signals transmitted/received between the portable device and an in-vehicle device installed in the mobile object have been developed.

By using the above-described technology, it is possible to perform control without using any cylinder key. For example, it is possible to allow unlocking of a door or starting of an engine of the mobile object in the case where authenticity of the portable device is confirmed through the authentication. This makes it possible to improve convenience.

On the other hand, in the case of attempting to further improve security while using the above-described technology, it is also considered that a condition for allowing unlocking of the door or stating of the engine is complicated.

Next, a case of authenticating a portable device and then making a determination on the basis of a distance between the mobile object and the portable device to improve security will be exemplified.

For example, it is possible to estimate the distance between the mobile object and the portable device through ranging based on transmission/reception of the UWB signals.

However, sometimes the ranging does not succeed on the first try because the UWB signals are easily affected by an object such as a human body.

Therefore, in the case of making a determination on the basis of the ranging, it is also considered that the ranging is performed more than once and a determination is made by using a representative value of a plurality of ranging values that have been acquired (such as an average value or a ranging value representing a shortest distance, for example).

However, here, in the case of making a determination in view of all results of ranging performed more than once, time it takes to obtain a determination result increases as the number of times of the ranging gets larger. This results in reduction in responsiveness.

The technical idea of the present invention was conceived by focusing on the above-described points, and makes it possible to improve security and assure responsiveness.

Next, details of operation of the system 1 according to the present embodiment for achieving the above-described purposes will be described.

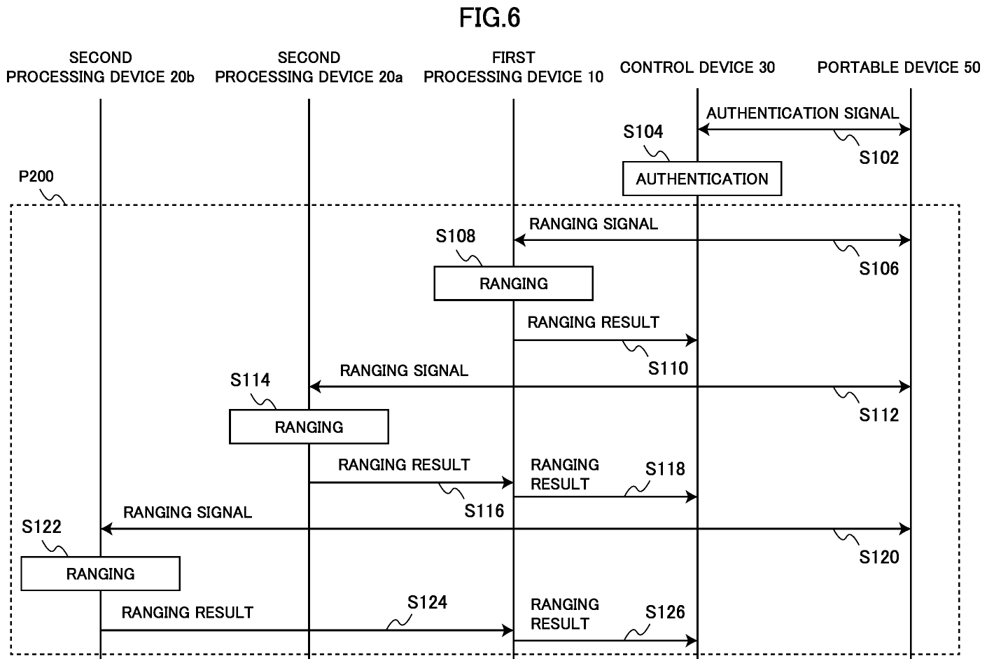

FIG. 6 is a sequence diagram illustrating an example of a flow of information communication in the system 1 according to the present embodiment. Note that, FIG. 6 illustrates an example in which the ranging is performed as the designated process according to the present embodiment.

In addition, in the example illustrated in FIG. 6, the system 1 according to the present embodiment includes the second processing device 20a and the second processing device 20b.

First, authentication signals are transmitted and received between the control device 30 and the portable device 50 in the case of the example illustrated in FIG. 6 (Step S102).

For example, the authentication signals may include a first authentication signal and a second authentication signal, which meet the second communication standard.

For example, the wireless communication section 320 of the control device 30 may transmit the first authentication signal. The first authentication signal is the LF band signal for requesting information to be used for authentication of the portable device 50.

In addition, in response to the first authentication signal, the second wireless communication section 530 of the portable device 50 may transmit the second authentication signal. The second authentication signal is the UHF band signal and includes the information, which is to be used by the control device 30 to authenticate the portable device 50.

Note that, examples of the information to be used for authentication of the portable device 50 include an identifier of the portable device 50, a password, a calculation result, and the like. The calculation result is calculated by using a random number included in the first authentication signal and key information that is shared in advance (such as a hash value calculated by using a hash function).

The control section 310 of the control device 30 authenticates the portable device 50 (Step S104) on the basis of the above-described authentication signals transmitted/received in Step S102.

Next, the first processing device 10, the second processing device 20a, and the second processing device 20b transmit/receive ranging signals to/from the portable device 50 in a prescribed order, and perform ranging on the basis of the ranging signals.

First, the ranging signals are transmitted and received between the first processing device 10 and the portable device 50 in the case of the example illustrated in FIG. 6 (Step S106).

The ranging signals may include a first ranging signal and a second ranging signal, which meet the first communication standard.

For example, the wireless communication section 120 of the first processing device 10 may transmit the first ranging signal, and the first wireless communication section 520 of the portable device 50 may transmit the second ranging signal in response to the first ranging signal.

In this case, the processing section 110 of the first processing device 10 performs ranging (Step S108) on the basis of the first ranging signal that has been transmitted from the wireless communication section 120 and the second ranging signal that has been transmitted from the first wireless communication section 520 of the portable device 50 and received by the wireless communication section 120.

At this time, it is possible for the processing section 110 of the first processing device 10 to calculate a ranging value on the basis of a time period ΔT1 and a time period ΔT2. The ranging value is an estimation value of a distance between the mobile object 40 and the portable device 50 (more precisely, a distance between the wireless communication section 120 of the first processing device 10 and the first wireless communication section 520 of the portable device 50). The time period ΔT1 is a time period from when the wireless communication section 120 transmits the first ranging signal to when the wireless communication section 120 receives the second ranging signal. The time period ΔT2 is a time period from when the first wireless communication section 520 of the portable device 50 receives the first ranging signal and to when the first wireless communication section 520 transmits the second ranging signal.

More specifically, it is possible for the processing section 110 of the first processing device 10 to calculate the time it takes to propagate the first ranging signal and the second ranging signal (that is, time it takes to perform round-trip communication) by subtracting the time period ΔT2 from the time period ΔT1. In addition it is possible for the processing section 110 to calculate the time it takes to propagate the first ranging signal or the second ranging signal (that is, time it takes to perform one-way communication) by dividing the calculated time by 2.

In addition, by multiplying the value obtained through (time period ΔT1−time period ΔT2)/2 by speed of the signals, it is possible for the processing section 110 of the first processing device 10 to calculate the estimation value of the distance between the mobile object 40 and the portable device 50, that is, the ranging value.

Note that, to calculate the ranging value by using the above-described method, it is necessary for the processing section 110 of the first processing device 10 to recognize the value of the time period ΔT2. Accordingly, the first wireless communication section 520 of the portable device 50 may transmit information related to the time period ΔT2 to the wireless communication section 120.

On the other hand, it is also possible to omit such transmission/reception of the information related to the time period ΔT2, by sharing the time period ΔT2 between the first processing device 10 and the portable device 50 as a preset fixed value.

In addition, the first ranging signal according to the present embodiment may be transmitted from the first wireless communication section 520 of the portable device 50, and the second ranging signal may be transmitted from the wireless communication section 120 of the first processing device 10 that has received the first ranging signal.

In this case, it is possible for the processing section 110 of the first processing device 10 to perform ranging by acquiring the information related to the time period ΔT1 from the portable device 50.

As described above, it is possible to flexibly modify the transmission/reception of ranging signals and the ranging based on the ranging signals according to the present embodiment.

For example, the processing section 110 of the first processing device 10 transmits a result (such as a ranging value) of the ranging performed in Step S108 to the control device 30 (Step S110).

In a similar way, the ranging signals are transmitted and received between the wireless communication section 220a of the second processing device 20a and the first wireless communication section 520 of the portable device 50 (Step S112), and the processing section 210a of the second processing device 20a performs ranging (Step S114) on the basis of the ranging signals transmitted/received in Step S112.

For example, the processing section 210a of the second processing device 20a transmits a result of the ranging performed in Step S114 to the first processing device 10 (Step S116), and the first processing device 10 transmits the result of ranging received in Step S116 to the control device 30 (Step S118).

In a similar way, ranging signals are transmitted and received between the wireless communication section 220b of the second processing device 20b and the first wireless communication section 520 of the portable device 50 (Step S120), and the processing section 210b of the second processing device 20b performs ranging (Step S122) on the basis of the ranging signals transmitted/received in Step S120.

For example, the processing section 210b of the second processing device 20b transmits a result of the ranging performed in Step S122 to the first processing device 10 (Step S124), and the first processing device 10 transmits the result of ranging received in Step S124 to the control device 30 (Step S126).

In addition, one of features of the system 1 according to the present embodiment is to cause the first processing device 10 and the second processing devices to perform ranging more than once.

For example, in the case of the example illustrated in FIG. 6, a series of processes P200 including Step S106 to Step S126 is repeated more than once.

In other words, in the case of the example illustrated in FIG. 6, a set including transmission/reception of ranging signals between the portable device 50 and the first processing device 10, ranging based on the ranging signals, transmission/reception of ranging signals between the portable device 50 and the second processing device 20a, ranging based on the ranging signals, transmission/reception of ranging signals between the portable device 50 and the second processing device 20b, and ranging based on the ranging signals may be repeatedly executed more than once.

Such control makes it possible to drastically improve a possibility of acquiring a ranging value through any of the ranging performed more than once by the respective processing devices, and this also makes it possible to avoid a situation where it is difficult to control a control target device due to failure of acquisition of a ranging value.

Note that, the flow of operation illustrated in FIG. 6 is a mere example. The flow of operation of the system 1 according to the present embodiment is not limited thereto.

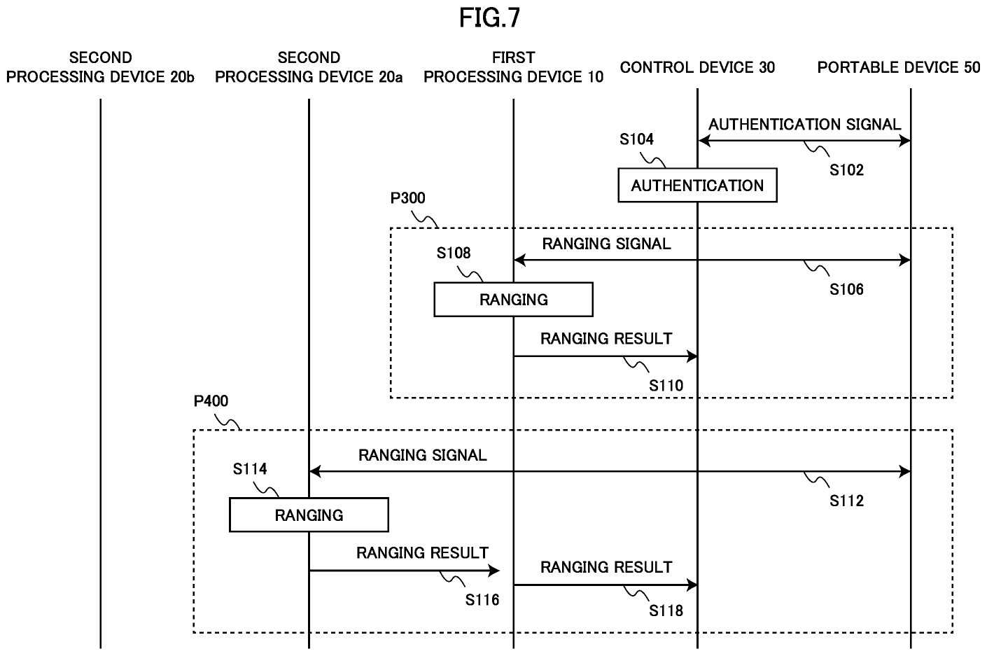

For example, in the case of the example illustrated in FIG. 7, a series of processes P300 including Step S106 to Step S110 is executed more than once, and then a series of processes P400 including Step S112 to Step S118 is executed more than once.

In addition, after the series of processes P400 is executed more than once, a series of processes P 500 including Step S120 to Step S126 illustrated in FIG. 6 is executed more than once. However, the series of processes P 500 is not illustrated in FIG. 7 in view of the size of the drawing.

In other words, according to the present embodiment, it is also possible to transmit/receive the ranging signals and perform ranging based on the ranging signals sequentially with regard to the respective combinations of the devices.

Even in this case, it is possible to drastically improve a possibility of acquiring a ranging value through any of the ranging performed more than once by the respective processing devices, and this also makes it possible to avoid a situation where it is difficult to control a control target device due to failure of acquisition of a ranging value, in a way similar to the above.

The examples of the flow of information communication in the system 1 according to the present embodiment have been described above. As illustrated in FIG. 6 and FIG. 7, the ranging signals are sequentially transmitted and received between the portable device 50 and the respective processing devices in the system 1 according to the present embodiment, and the ranging is performed more than once on the basis of the ranging signals.

In this case, the control section 310 of the control device 30 according to the present embodiment may control execution of the subsequent process on the basis of a ranging result determined as a ranging result that satisfies a designated condition for the first time, among a plurality of ranging results that have been acquired.

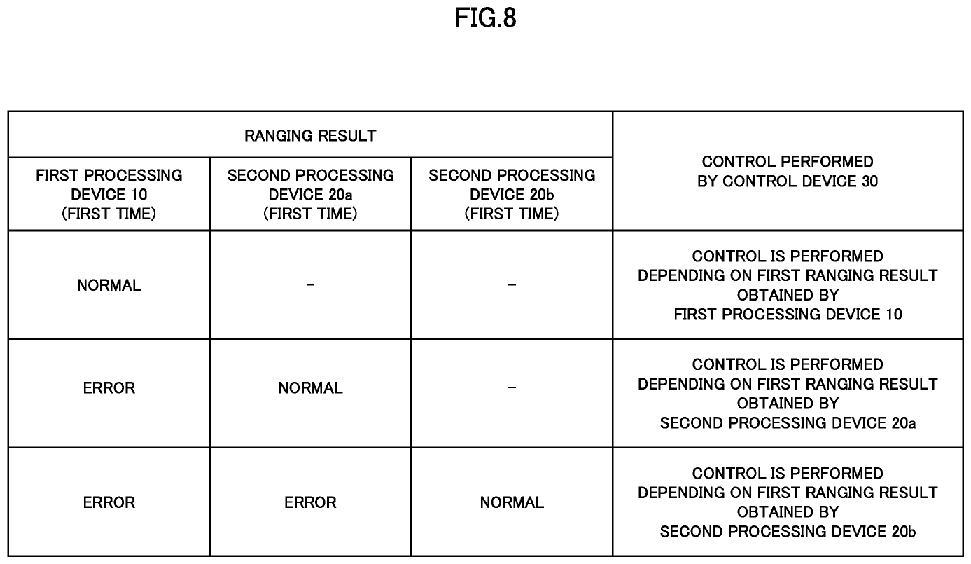

FIG. 8 is a diagram illustrating an example of control over subsequent processes based on the ranging results according to the present embodiment.

In the case of the example illustrated in FIG. 8, the designated condition may be a condition that ranging is completed normally and a ranging value is acquired. In FIG. 8, wording “normal” means that a ranging value is acquired, and wording “error” means that no ranging value is acquired.

In addition, FIG. 8 illustrates an example of control performed in the case where the series of processes P 200 is repeatedly executed as illustrated in FIG. 6.

For example, it is assumed that a first ranging result that has been obtained for the first time by the first processing device 10 and received by the control section 310 of the control device 30 in Step S110 in FIG. 6 is a “normal” result.

In this case, the control section 310 may control a subsequent process by using the first ranging result obtained by the first processing device 10, without waiting for first ranging results obtained for the first time by the second processing device 20a and the second processing device 20b or second and subsequent ranging results obtained by the respective processing devices.

Alternatively, for example, it is assumed that a first ranging result that has been obtained for the first time by the first processing device 10 and received by the control section 310 of the control device 30 in Step S110 in FIG. 6 is an “error” result, and a first ranging result that has been obtained by the second processing device 20a and received in Step S118 is a “normal” result.

In this case, the control section 310 may control a subsequent process by using the first ranging result obtained by the second processing device 20a, without waiting for a first ranging result obtained for the first time by the second processing device 20b or second and subsequent ranging results obtained by the respective processing devices.

Alternatively, for example, it is assumed that a first ranging result that has been obtained for the first time by the first processing device 10 and received by the control section 310 of the control device 30 in Step S110 in FIG. 6 and a first ranging result that has been obtained for the first time by the second processing device 20a and received in Step S118 are “error” results, and a first ranging result that has been obtained for the first time by the second processing device 20b and received in Step S126 is a “normal” result.

In this case, the control section 310 may control a subsequent process by using the first ranging result obtained by the second processing device 20b, without waiting for second and subsequent ranging results obtained by the respective processing devices.

Such control makes it possible to control the subsequent process when a valid ranging result is obtained without waiting for another ranging result, and it is possible to improve security and assure responsiveness.

Note that, FIG. 8 illustrate the example in which the designated condition is a condition that a ranging value is acquired. However, the designated condition according to the present embodiment is not limited thereto.

For example, the designated condition according to the present embodiment may be a condition that an acquired value falls within a designated range.

In this case, the control section 310 of the control device 30 according to the present embodiment may control execution of the subsequent process on the basis of a ranging value determined as a ranging value that falls within the designated range for the first time, among respective ranging values acquired through ranging performed more than once by the first processing device 10 and the at least one or more second processing devices 20.

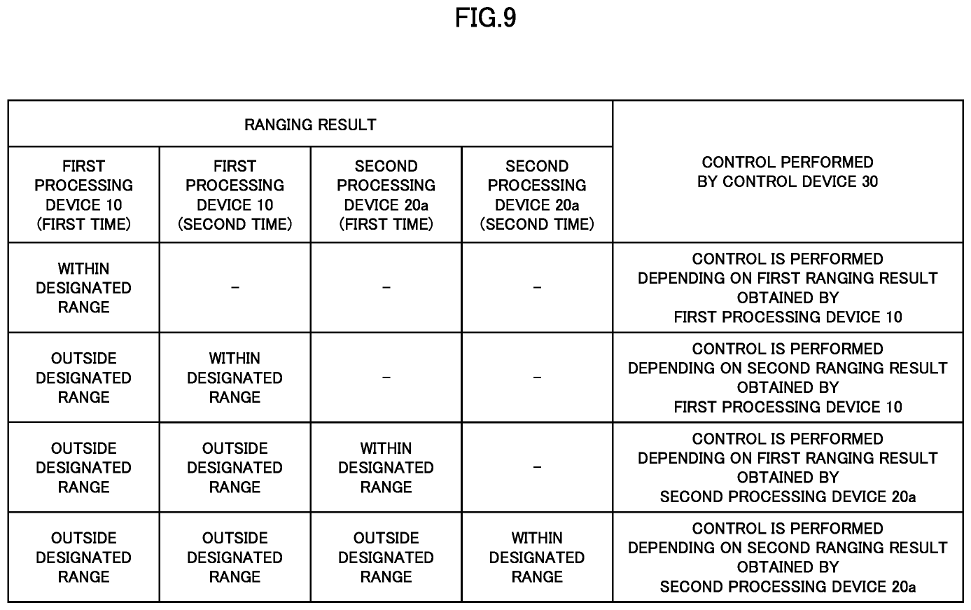

FIG. 9 is a diagram illustrating an example of control over subsequent processes based on ranging values according to the present embodiment.

Note that, FIG. 9 illustrates an example of control performed in the case where the series of processes P300 is repeatedly executed more than once and then the series of processes P 400 is executed more than once as illustrated in FIG. 7. In addition, in the example illustrated in FIG. 9, it is assumed that the number of repetitions of the series of processes P300 and the series of processes P400 is two. In addition, hereinafter, different numerals, each of which represents the number of execution, are suffixed to respective step numbers representing steps included in the series of processes P300 and the series of processes P400 that are repeatedly executed, to make them distinguishable from each other.

For example, it is assumed that a ranging value included in a first ranging result that has been obtained for the first time by the first processing device 10 and received by the control section 310 of the control device 30 in Step S110-1 in FIG. 7 is a ranging value that falls “within the designated range”.

In this case, the control section 310 may control a subsequent process by using a ranging value calculated through first ranging performed for the first time by the first processing device 10, without waiting for a second ranging result obtained by the first processing device 10, first and subsequent ranging results obtained by the second processing device 20a, or first and subsequent ranging result obtained by the second processing device 20b.

Alternatively, for example, it is assumed that a ranging value included in a first ranging result that has been obtained by the first processing device 10 and received by the control section 310 of the control device 30 in Step S110-1 in FIG. 7 is a ranging value that falls “outside the designated range”, and a ranging value included in a second ranging result that has been obtained by the first processing device 10 and received in Step S110-2 is a ranging value that falls “within the designated range”.

In this case, the control section 310 may control a subsequent process by using a ranging value calculated through second ranging performed for a second time by the first processing device 10, without waiting for first and subsequent ranging results obtained by the second processing device 20a, or first and subsequent ranging results obtained by the second processing device 20b.

Alternatively, for example, it is assumed that a ranging value included in a first ranging result that has been obtained for the first time by the first processing device 10 and received by the control section 310 of the control device 30 in Step S110-1 in FIG. 7 and a ranging value included in a second ranging result that has been obtained for a second time by the first processing device 10 and received in Step S110-2 are ranging values that fall “outside the designated range”, and a ranging value included in a first ranging result that has been obtained by the second processing device 20a and received in Step S118-1 is a ranging value that falls “within the designated range”.

In this case, the control section 310 may control a subsequent process by using a ranging value calculated through first ranging performed for the first time by the second processing device 20a, without waiting for a second ranging result obtained by the second processing device 20a, or first and subsequent ranging results obtained by the second processing device 20b.

Alternatively, for example, it is assumed that a ranging value included in a first ranging result that has been obtained for the first time by the first processing device 10 and received by the control section 310 of the control device 30 in Step S110-1 in FIG. 7 and a ranging value included in a second ranging result that has been obtained for a second time by the first processing device 10 and received in Step S110-2 are ranging values that fall “outside the designated range”, and a ranging value included in a second ranging result that has been obtained for a second time by the second processing device 20a and received in Step S118-2 is a ranging value that falls “within the designated range”.

In this case, the control section 310 may control a subsequent process by using the ranging value calculated through second ranging performed for the second time by the second processing device 20a, without waiting for first and subsequent ranging results obtained by the second processing device 20b.

Such control makes it possible to assure responsiveness by controlling the subsequent process when a valid ranging value is obtained without waiting for another ranging result, and to further improve security by making a stricter determination on the basis of the ranging value.

Note that, it is possible for the control section 310 according to the present embodiment to perform control in such a manner that the subsequent process is executed when the authenticity of the portable device 50 is confirmed through the authentication in Step S104 in FIG. 6 or FIG. 7 and a result of the designated process is obtained. The result is determined as a result that satisfies the designated condition.

In addition, it is also possible for the control section 310 of the control device 30 or the processing section 110 of the first processing device 10 to determine whether or not the result of the designated process according to the present embodiment satisfies the designated condition.

For example, as illustrated in FIG. 6 and FIG. 7, it is possible for the control section 310 of the control device 30 to make a determination as described above by receiving a result of the designated process from the first processing device 10.

In addition, for example, it is also possible for the processing section 110 of the first processing device 10 to determine whether or not a result of the designated process executed by the processing section 110 satisfies the designated condition, determine whether or not a result of the designated process, which has been received from the second processing device 20, satisfies the designated condition, and transmit the results of the determination to the control device 30 in addition to the respective results of the designated process.

Note that, in this case, the processing section 110 of the first processing device 10 may transmit the result of the designated process to the control device 30 only when the obtained result of the designated process satisfies the designated condition.

In addition, the processing section 110 of the first processing device 10 may perform control in such a manner that subsequent ranging is canceled when a result of the designated process is obtained and the obtained result satisfies the designated condition.

Alternatively, it is also possible for the processing section 210 of the second processing device 20 according to the present embodiment to determine whether or not a result of the designated process executed by the processing section 210 satisfies the designated condition, and transmit a result of the determination to the first processing device 10 in addition to the result of the designated process.

The flow of the operation of the system 1 according to the present embodiment can be flexibly modified.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

Note that, a series of processes performed by the respective devices described in this specification may be implemented by any of software, hardware, and a combination of software and hardware. A program that configures the software is stored in advance in, for example, a non-transient storage medium installed inside or outside each of the devices. In addition, for example, when a computer executes each of the programs, the program is loaded into RAM, and executed by a processor such as a CPU. The storage medium may be a magnetic disk, an optical disc, a magneto-optical disc, flash memory, or the like, for example. Alternatively, the above-described computer program may be distributed via a network without using the storage medium, for example.

What is claimed is:

1. A system comprising:
a first processing device;
at least one or more second processing devices; and
a control device,
wherein the first processing device and the at least one or more second processing devices execute respective designated processes more than once, and
the control device controls execution of a subsequent process, which follows the designated process, on a basis of a result determined as a result that satisfies a designated condition for first time, among results of the respective designated processes executed more than once by the first processing device and the at least one or more second processing devices.

2. The system according to claim 1,
wherein the designated processes executed by the first processing device and the at least one or more second processing devices are same.

3. The system according to claim 1,
wherein the designated process is a process based on a result of wireless communication.

4. The system according to claim 3,
wherein the designated process is a process of estimating a positional relation among the first processing device, the at least one or more second processing devices, and a portable device carried by a user.

5. The system according to claim 4,
wherein the designated process includes ranging for estimating a distance between the portable device carried by the user and the first processing device or each of the at least one or more second processing devices.

6. The system according to claim 5,
wherein the control device controls execution of the subsequent process on a basis of a ranging value determined as a ranging value that falls within a designated range for first time, among respective ranging values acquired through ranging performed more than once by the first processing device and the at least one or more second processing devices.

7. The system according to claim 4,
wherein the control device performs authentication based on a wireless signal transmitted/received to/from the portable device, and controls execution of the subsequent process further on a basis of a result of the authentication.

8. The system according to claim 1,
wherein the first processing device, the at least one or more second processing devices, and the control device are installed in a same mobile object.

9. The system according to claim 1, wherein
the first processing device operates as a master that controls the at least one or more second processing devices that operate as slaves, and
the first processing device receives a result of the designated process or a determination result from the at least one or more second processing devices, the determination result indicating whether or not the result of the designated process satisfies the designated condition.

10. A control device comprising
a control section configured to control execution of a subsequent process, which follows a designated process, on a basis of results of the respective designated processes executed more than once by a plurality of processing devices,
wherein the control section controls execution of the subsequent process on a basis of a result determined as a result that satisfies a designated condition for first time, among the results of the respective designated processes executed more than once by the plurality of processing devices.

11. A processing device comprising
a processing section configured to execute a designated process more than once,
wherein the processing section transmits a result determined as a result that satisfies a designated condition for first time to a control device that executes a subsequent process following the designated process on a basis of the result, among results of the designated process executed more than once by the processing section and results of the designated process executed more than once by at least one or more other processing devices.
